(19) United States
(12) Patent Application Publication
(10) Pub. No.: US 2005/0259917 A1
(43) Pub. Date: Nov. 24, 2005

(54) Spatial phase filter for light beams, system and corresponding method

(75) Inventors: Alexandre Afonso, Brest (FR); Jean-Louis De Bougrenet De La Tocnaye, Guilers (FR)

Correspondence Address: MERCHANT & GOULD PC, P.O. BOX 2903, MINNEAPOLIS, MN, 55402-0903, US

(73) Assignee: OPTOGONE SA, Plouzane (FR)

(21) Appl. No.: 10/946,401

(22) Filed: Sep. 20, 2004

(30) Foreign Application Priority Data
Sep. 22, 2003 (FR) 03 11100

(51) Int. Cl. G02B 6/26

(52) U.S. Cl. 385/31

(57) ABSTRACT

The invention relates to a spatial phase filter capable of receiving an incident light beam so as to transmit it to a single mode output fibre comprising a spatially variable phase profile and being adapted to excite the evanescent modes of the output fibre. The profile has:
an adjustable pattern with a phase distribution substantially corresponding to a combination of at least one quantile of normal distribution on at least one dimension (301); and
a phase shifting zone support (320) limited in relation to the incident beam according to the dimension(s). The invention also relates to a system implementing several filters and a method for filter calculating.

### FIELD OF THE INVENTION

The invention relates to optical attenuators notably variable in the individual form of strips or arrays in the perspective, among others, of making variable wavelength selector blockers for WDM optical networks.

### DESCRIPTION OF THE PRIOR ART

The feature of this type of function is to require high attenuations (normally greater than 35 dB) and to operate on bandwidths of widths typically lying between 50 GHz and 100 GHz. Different techniques are used to reach this objective.

One of them consists in generating, by means of a spatial filter, interference on the optical light beam prior to it being injected into a single mode optical fibre, so as to excite the modes of greater order, which will thus be quickly attenuated. Given that it is desirable to optimise the insertion losses, we preferably resort to pure phase filters (normally binary for simplicity reasons).

This idea was notably disclosed in the articles “Excitation and scattering of modes on a dielectric or optical fibre” by Snyder (published in the magazine IEEE Trans. on Microwave Theory Vol. MIT 17, N^{o}12, 1969) and “Transfer function of long spliced graded index fibers with mode scramblers” by M. Ikeda and K. Kitayama (published in the magazine Applied Optics, Vol. 17, pp 63-67 in 1978). These articles describe techniques based on the introducing of an absorbent, scattering or diffracting element in a guide so as to excite the greater modes. Nonetheless, these techniques of the prior art have the inconvenience of not allowing to adjust the parameters via programming.

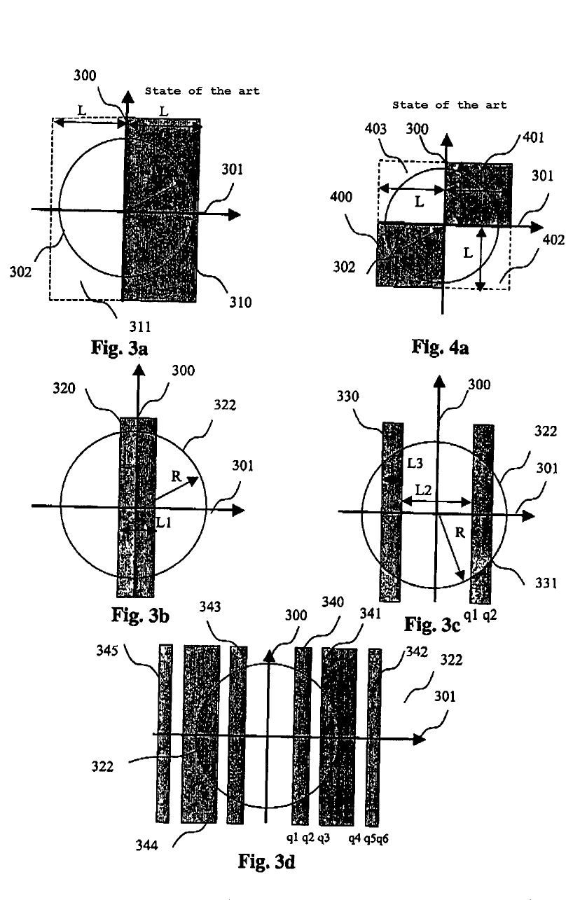

The international patent application WO 02/071133 by the Xtellus company® has an attenuator for optical fibre according to different embodiments relatively simple to implement. According to a technique illustrated in this patent application, an incident light beam passes through an electrically controlled liquid crystal zone. The electrodes are implemented so as to define pixels in a cross section of this zone. Thus according to a first embodiment illustrated in respects to FIG. 3a, the profile of a dimension of a section marked by a horizontal axis 301 and a vertical axis 300 respectively dividing the section in two parts of equal width L comprises two pixels 310 and 311, the pixel 310 being driven by the electrodes. The width L is greater than the radius R of the incident beam (represented by its neck in the case of a Gaussian beam), symbolised by its mark 302. Thus, by applying a pre-set voltage to the latter, the pixel 310 can be controlled in order to phase shift it in relation to the pixel 311 with a phase shifting:
equal to zero then the incident signal is not attenuated; or
equal to π, the incident signal being transformed in an high mode preventing the signal from penetrating into a single mode fibre and thus engendering a variable attenuation according to the applied voltage.

To summarise, the command applied to the electrodes allows to transform or not to transform the incident signal in a high mode only capable of propagating in an output fibre and therefore to attenuate it or not.

According to an alternative of the previous embodiment in the patent application WO 02/071133, the profile of a section is of two dimensions defining four square zones 400 to 403 of equal length L and separated by the axes 300 and 301. Each of the zones 400 to 403 can be driven by distinct electrodes.

This technique of the prior art has the inconvenience of not being optimised for the coupling of modes of greater order. Moreover, neither is its implementation optimised, in particular for embodiments adapted to independently filter several wavelengths.

One of the alternative embodiments has a better tolerance to positioning errors in the presence of a positioning error in relation to an incident beam. Nevertheless, this alternative is not optimised in respects to the coupling coefficient (loss of attenuation dynamics).

### OBJECTIVES OF THE INVENTION

The invention according to its different features notably has the objective of overcoming these inconveniences of the prior art.

More precisely, an objective of the invention is to envisage optimal optical filters for decoupling in a single mode optical fibre.

Another objective of the invention is to allow filters relatively simple to implement, notably in the form of strips or arrays, allowing in particular to reduce their dimensions.

Yet another objective of the invention is to guarantee good positioning tolerance and therefore to facilitate the optical arrangement.

An objective of the invention is also to allow for the implanting of optical filters that can be based on various technologies.

For this reason, the invention proposes a spatial phase filter capable of receiving an incident light beam so as to transmit it to a single mode output fibre, the filter being adapted to be positioned substantially perpendicular to the direction of propagation of the beam and comprising a spatially variable phase profile and being adapted to excite the evanescent modes of the output fibre. The filter is remarkable in that is has:
an adjustable pattern with a phase distribution substantially corresponding to a combination of at least one quantile of normal distribution on at least one dimension and;
a phase shifting zone support limited in relation to the incident beam according to the dimension(s).

Moreover, the adjustable pattern follows a phase distribution substantially corresponding to a combination of at least one quantile of normal distribution on this or these dimensions. Thus, in the case of a constant amplitude of the signal A on a support D (in a (x,y) plane) that can vary between 1 (when there is no attenuation) to 0 (when there is complete attenuation), the phase distribution corresponds to a quantile of normal distribution according to the following relation:

$$\int {\int }_{D} \frac{{ⅇ}^{- \frac{{x}^{2}}{2}}}{\sqrt{2 π}} ⅆ x \cdot \frac{{ⅇ}^{- \frac{{y}^{2}}{2}}}{\sqrt{2 π}} ⅆ y = \frac{1}{1 + A} .$$

According to a special feature, the spatial filter is remarkable in that the profile has a adjustable pattern with a phase distribution substantially corresponding to an odd quartile of normal distribution on a dimension perpendicular to the direction of propagation of the incident beam.

Thus, the phase shifting zone support is limited:
on one dimension: the footprint of the incident beam (or of its neck in the case of a Gaussian beam), completely covers the adjustable pattern according to this dimension; or
on two dimensions: the footprint of the incident beam (or of its neck in the case of a Gaussian beam), completely covers the adjustable pattern according to the two dimensions of a plane perpendicular (cross sectional plane) to the direction of propagation of the beam.

An odd quartile of normal distribution is defined according to one of the following relations:

$$\begin{matrix}{\int }_{- ∞}^{q} \frac{{ⅇ}^{- \frac{{x}^{2}}{2}}}{\sqrt{2 π}} ⅆ x = \frac{1}{4} & ( quartile 1 ) \\ or & \\ {\int }_{- ∞}^{q} \frac{{ⅇ}^{- \frac{{x}^{2}}{2}}}{\sqrt{2 π}} ⅆ x = \frac{3}{4} & ( quartile 3 )\end{matrix}$$

where q represents the quartile. The latter represents the limit (x co-ordinate according to the limited dimension) of the adjustable part of the filter.

According to a special feature, the spatial filter is remarkable in that its phase distribution substantially corresponds to a third quartile of normal distribution on the dimension.

These one dimension filters are optimal for decoupling in a single mode optical fibre. Among these filters, the odd quartiles (notably the third quartile) have the decisive advantage in terms of the taking into account of their technological implantation. They notably allow to reduce the size of the active zone compared to the neck of the Gaussian beam.

This property is particularly interesting when several filters are associated in the form of strips or arrays notably required for making DCE (Dynamic Channel Equalizer) or ROADM (Reconfigurable Optical Add & Drop Multiplexer) as the use of quartile of order 3 allows to optimise the zone between each phase shifting or delaying zone without any loss in resolution nor any additional bandwidth constraints.

The use of quartile of order 3 is also particularly interesting when the means of phase shifting comprise electro-optic adjusting elements (anisotropic (for example liquid crystal type) or isotropic (for example nano-PDLC type)) as they allow to optimise the surface area of the active zone compared to the surface area of the spot (corresponding to the incident light beam, the reference being taken from the surface area covered by the neck of the beam). This notably allows to limit the transversal field effects due to the neighbouring pixels.

Moreover, the use of the third quartile in a system comprising several filters allows for easier optical passivation of the intermediary zone (comprising, for example, a photosensitive resin, glass, silicon or any other element likely to be etched bearing a fixed delay compared to a central zone of the adjustable system (notably thanks to an electro-optic or electro-mechanic element)). Thus, phase transitions are obtained that are stiffer than through using a continuously adjustable strip (SLM).

Moreover, using the third quartile allows for easier electric insulation of the intermediary zone separating two active zones corresponding to two filters and thus a reduction in the transversal field effects when the phase shifting material is electro-optic.

It is noted that the material separating two distinct filters can be both an electric insulator and an optical passivator.

According to a specific feature, the spatial filter is remarkable in that the combination is a sum of at least one difference of two quantiles of normal distribution on a dimension perpendicular to the direction of propagation of the incident beam, the sum being equal to ¼ or ¾.

The filter is thus optimised.

According to a specific feature, the spatial filter is remarkable in that is has an axial symmetry.

Thus, a better tolerance to the positioning errors of the filter in relation to an incident beam.

According to a specific feature, the spatial filter is remarkable in that the profile has:
an adjustable pattern with a phase distribution substantially corresponding to a combination of at least one quantile of normal distribution on the two dimensions of a transversal plane in relation to the incident beam; and
an active zone support limited in relation to the incident beam according to the two dimensions.

Thus filters particularly interesting to implement in the form of arrays with several filters are obtained.

According to a specific feature, the spatial filter is remarkable in that the combination belongs to the group comprising:
a quantile of normal distribution; and
a difference of two distinct quantiles of normal distribution.

According to a specific feature, the spatial filter is remarkable in that it has punctual symmetry.

Thus a better tolerance to positioning errors of the filter in relation to the incident beam are also obtained.

In the case of implementing in the form of arrays of elementary filters, the size of the array is optimised when the elementary filters are square or disk shaped (especially between reduced elementary filters).

According to a specific feature, the spatial filter is remarkable in that a first part of the profile is square or rectangular on the dimension(s).

A filter of square or rectangular profile on at least one part (for example binary or more than two values) is relatively simple to implement if the means for phase shifting are suitable (notably the case of means for electro-optic phase shifting).

According to a specific feature, the spatial filter is remarkable in that phase shifting on the first part of the profile is equal to π.

Thus, the evanescent modes of the output fibre are excited when the filter is activated thus allowing to attenuate or block the optical light beam.

According to a specific feature, the spatial filter is remarkable in that a second part of the profile is parabolic on the dimension(s).

The profile is thus entirely or partly parabolic (another part can thus notably be linear).

The filter of parabolic profile is particularly well suited to a filter with means for phase shifting based on the use of electromagnetic mirrors with membranes whose distortion is itself parabolic.

According to a specific feature, the spatial filter is remarkable in that a third part of the profile is triangular on the dimension(s).

The profile is thus entirely or partly triangular (another part can thus notably be parabolic or rectangular).

In order to minimise the dimension of the active zone of the filter of respectively parabolic and triangular profile, the corresponding maximum phase shifting will preferably be chosen substantially equal to respectively 3π/2 and 8π/5.

According to a specific feature, the spatial filter is remarkable in that it comprises means for controlling the variable attenuation on one part of the profile.

According to a specific feature, the spatial filter is remarkable in that the means comprise at least an electro-optic or electro-mechanic adjusting element that can be controlled.

The invention also relates to a system capable of receiving at least one light beam and comprising at least a filter such as is previously described and more precisely a spatial phase filter capable of receiving an incident light beam so as to transmit it to a single mode output fibre, the filter being the filter being adapted to be positioned substantially perpendicular to the direction of propagation of the beam and comprising a spatially variable phase profile and being adapted to excite the evanescent modes of the output fibre, the profile of the filter having:
an adjustable pattern with a phase distribution substantially corresponding to a combination of at least one quantile of normal distribution on at least one dimension; and
a phase shifting zone support limited in relation to the incident beam according to the dimension(s).

According to a specific feature, the system is remarkable in that it comprises at least two of the filters.

Thus, the filters optimising both the coupling of the modes of greater order and the technological implantation, are particularly well adapted for implementing, for example, in the form of strips or arrays with several filters.

According to a specific feature, the system is remarkable in that each of the filters comprises an electrically controlled adjusting zone.

Thus, the system can be implemented in the form of a particularly compact device.

According to a specific feature, the system is remarkable in that comprises means for imaging, at least one of the filters being positioned in an imaging plane of the means for imaging.

The system is thus formed with, for example, lenses and equivalent means can comprise several imaging planes. Optical elements capable of performing a function specific to the system (notably wavelength multiplexing, demultiplexing, amplifying . . . ) can be advantageously introduced into the lens focal planes of the means for imaging.

According to a specific feature, the system is remarkable in that it comprises means for wavelength demultiplexing of the light beam(s) so as to create demultiplexed light beams intended to be filtered by the filters.

Such a system can be made based on means for multiplexing/demultiplexing, for example of prism type associated with fibres or means for imaging or even phaser type according to the principle of an AWG (Arrayed Wave Guide).

According to a specific feature, the system is remarkable in that it comprises means for selective blocking of at least some wavelengths of the light beam(s).

According to a specific feature, the system is remarkable in that it comprises means for routing the light beam.

Thus, the filter systems according to the invention are suited to the implanting of wavelength and spatial routing functions notably of DCE and ROADM type.

The invention moreover relates to a method for filter calculating such as previously described, the method comprising:
a step for determining a coupling coefficient of the filter according to a phase profile, a phase maximum and a filter support;
a step for minimising the coupling coefficient; and
a step for determining the support substantially corresponding to a minimal coupling coefficient.

Thus, optimised filters can be made so that, for example, the phase distribution substantially corresponds to an odd quartile of normal distribution for a dimension or to a combination of quartiles of normal distribution for two dimensions.

The advantages of the system and method are the same as for the filter. They are not described in greater detail.

Other features and advantages of the invention become clearer upon reading the following description of a preferred embodiment, given by way of example and non restrictive, and of the annexed drawings, among which:

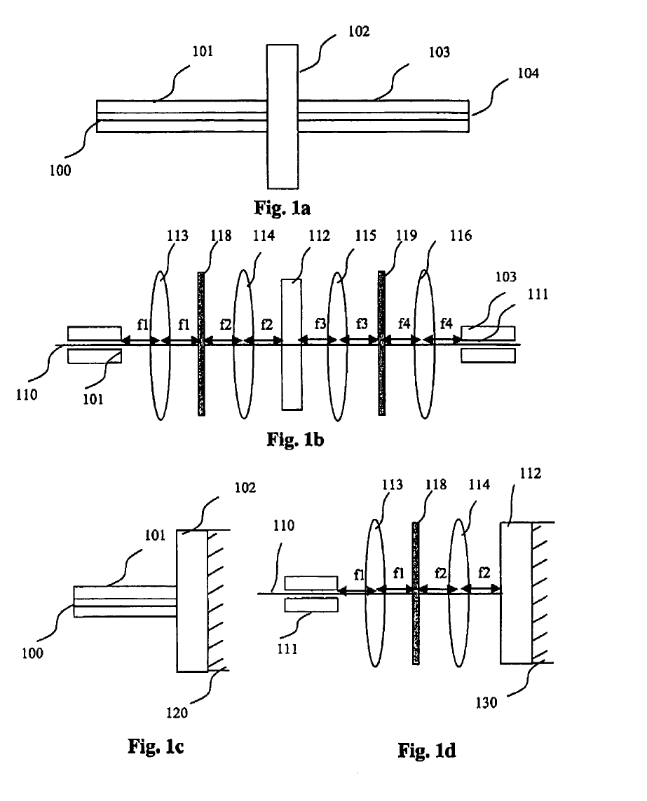

FIGS. 1a to 1d present a block diagram of an optical filtering system in compliance with the invention according to different specific embodiments;

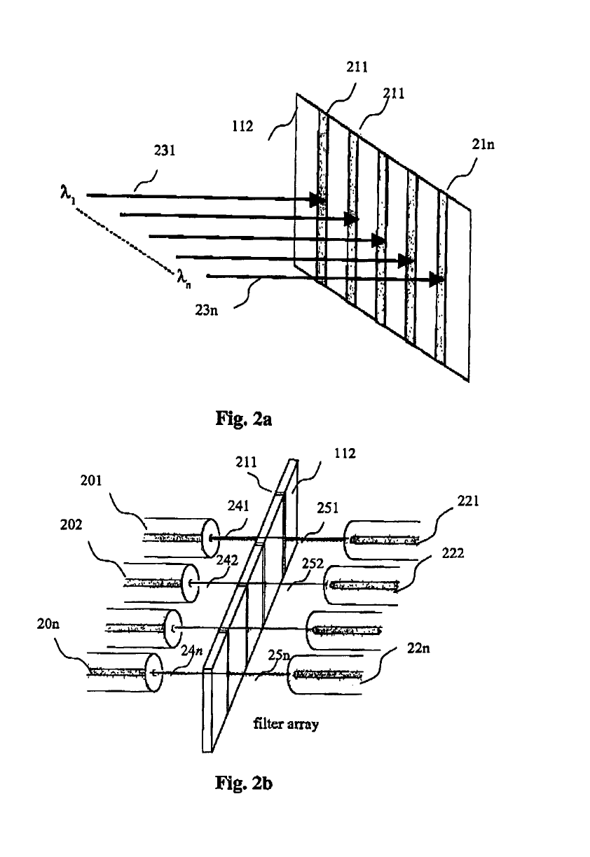

FIGS. 2a and 2b illustrate filtering systems comprising a strip of optical filters such as described in FIG. 1a;

FIGS. 3a, 4a, 6a and 6b illustrate filters known in themselves;

FIGS. 3b to 3d present one dimension quantile filters implemented in the systems in FIGS. 1a to 1d according to alternative embodiments of the invention;

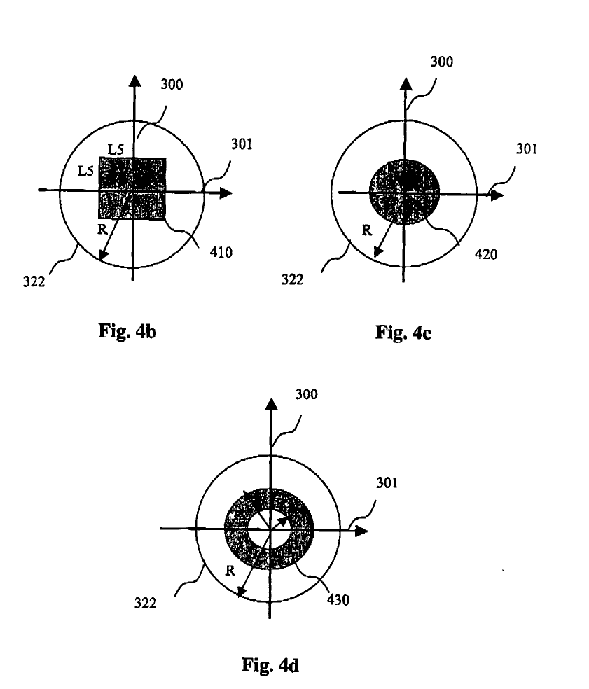

FIGS. 4b to 4d illustrate two dimension quantile filters implemented in the systems in FIGS. 1a to 1d according to alternative embodiments of the invention;

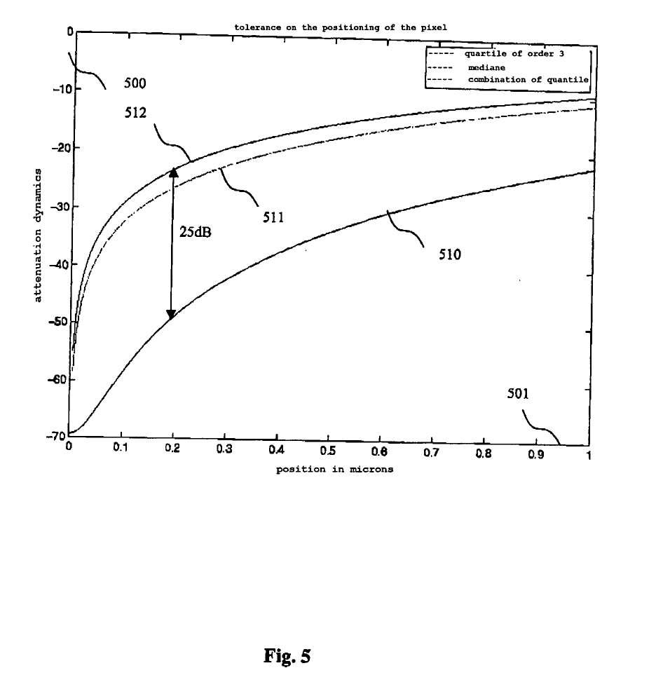

FIG. 5 represents tolerance curves on the position of the pixel in the systems in FIGS. 1a to 1d;

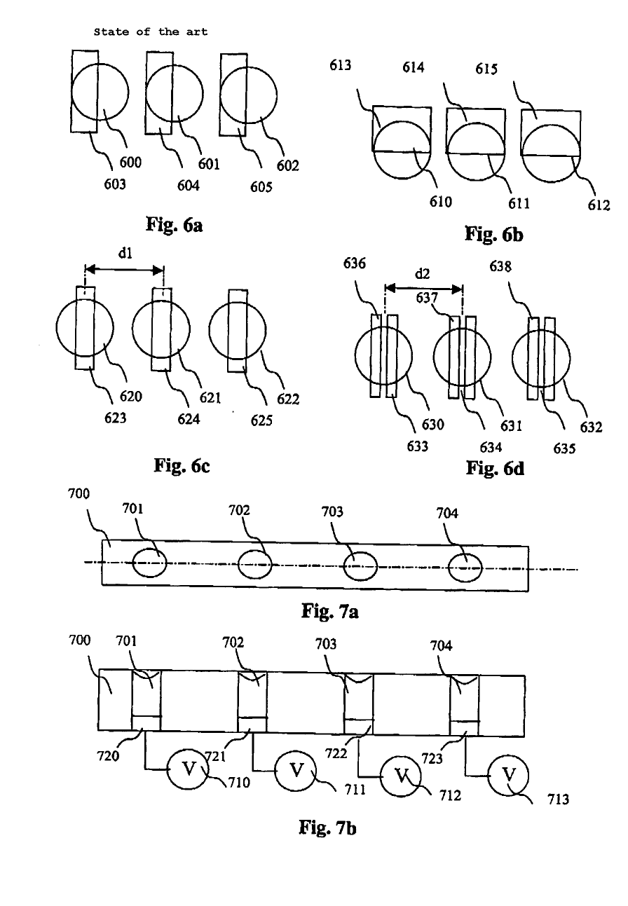

FIGS. 6a to 6d diagrammatically describe the size and the position of a spot of light in relation to the pixels in the filters in FIGS. 1a to 1d;

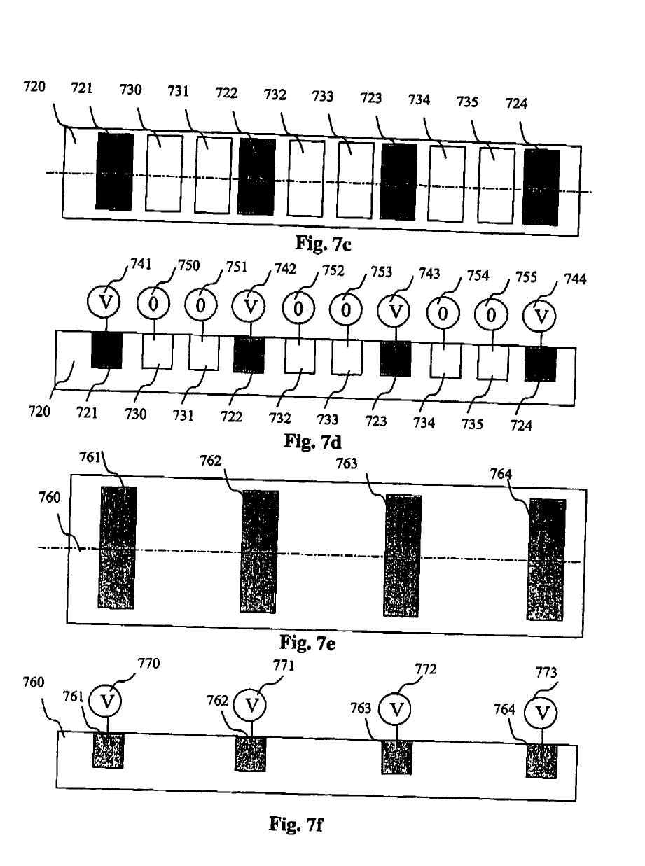

FIGS. 7a to 7f illustrate a passivation of filters presented in respect to FIGS. 1a to 1d;

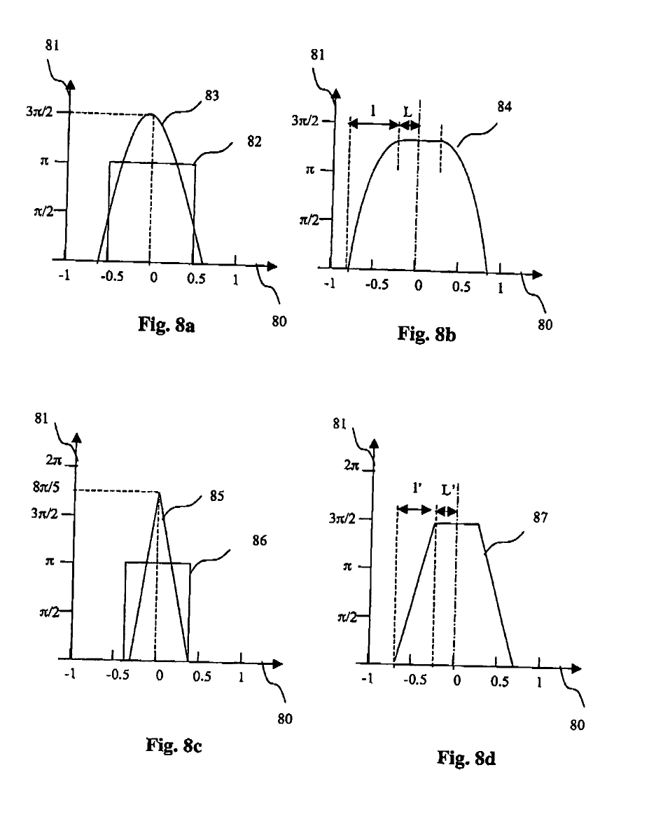

FIGS. 8a to 8d present radial or trapezoidal parabolic profiles of one dimension filters such as illustrated in FIGS. 1a to 1d; and

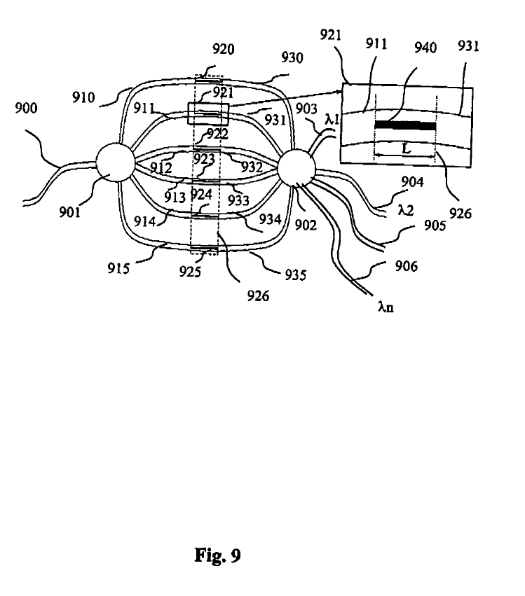

FIG. 9 describes a structure of an AWG based equaliser implementing the filters according to the invention.

### DETAILED DESCRIPTION OF THE INVENTION

The overall principle of the invention lie in a category of filters allowing for an optimal decoupling of the energy injected into a single mode optical fibre.

Among these filters, a category of axial or punctual symmetry filters has the advantage of providing a better alignment tolerance of which some, that will be described, are easier to implant and well adapted to the making of DCE and ROADM.

A filter type, which in addition has the advantage of optimising the pixel gap well suited for implantation in the form of spatial light modulators (SLM) in the context of making a DCE, is preferably selected for the making of strips or filter arrays. Different technical embodiments are possible according to the technological choice associated with the means for optical attenuating (electro-optic or electro-mechanic) or with the means for transmitting the light beams (fibres alongside the filters, means for focalising, multiplexers or demultiplexers, means for routing, amplifying . . . ).

The filters are considered as thin and preferably do not introduce any Gaussian beam distortion other than the phase shifting (notably no field curving or neck enlarging).

FIGS. 1a to 1d have different embodiments according to the invention.

More precisely, FIG. 1a illustrates a filter 102 or spatial light modulator, according to the invention, placed between two single mode optical fibres 101 and 103 respectively allowing to propagate an incident beam 100 and an output beam 104. According to the invention, the active zone of the filter 102 has a support limited in at least one dimension, meaning that the width of the corresponding adjustable pattern is strictly smaller than that of an incident optical beam represented by its neck in the case of a Gaussian beam. The fibres 101 and 103 are alongside the filter 102. One or several control voltages of the filter 102 allow to a greater or lesser extent phase shift the incident beam 100 in order to obtain the output beam 104, the variable attenuation appearing at the time of coupling the output beam.

FIG. 1b presents a DCE with a similar architecture to that of the system in FIG. 1a, the filter 102 being replaced by a strip of filters 112, according to the invention, and in addition comprising imaging systems with multiplexers or demultiplexers. According to the invention, the active zone of each strip of filters 112 has a support limited in at least the dimension according to which the pattern is replicated, meaning that the corresponding adjusting pattern has a strictly smaller width (taken from the dimension where the pattern is replicated) than that of an incident optical beam represented by its neck in the case of a Gaussian beam. More precisely, the DCE successively comprises:
an input fibre 101 conveying a light beam 110;
a first imaging system capable of creating a spatially demultiplexed image of the light beam 110 (according to its wavelengths) on the filter 102;
the strip of filters 112;
a second imaging system capable of creating a multiplexed image at the opening of an output fibre 103 from the beam image passing through the strip of filters 112; and
the output fibre 103 conveying a beam 111 equalised by the strip of filters 112 according to the wavelengths of the incident beam 110.

According to an alternative of the invention, means for collimating are placed between the input fibre 101 and the imaging system and between the second imaging system and the output fibre 103. These means for collimating are preferably alongside the respective input 101 and output 103 fibres.

The first imaging system successively comprises:
a lens 113 of focal distance f1 located at the distance f1 from the outlet of the fibre 101;
a demultiplexer 118 (for example a prism) capable of spatially demultiplexing the incident beam according to its wavelength(s), and located at the distance f1 from the lens 113, the incident beam therefore being image transferred onto the demultiplexer 118;
a lens 114 of focal distance f2 located at the distance f2 from the demultiplexer 118 and from the strip of filters 112, the demultiplexed beam therefore being image transferred (with its spatially separated spectral components) onto the strip 112.

The second imaging system successively comprises:
a lens 115 of focal distance f3 located at the distance f3 from the strip 112;
a multiplexer 119 (for example a prism) capable of multiplexing the incident beam equalised by the strip 112 according to its spectral components, and located at the distance f3 from the latter;
a lens 116 of focal distance f4 located at the distance f4 from the multiplexer 119 and from the output fibre 103, the equalised and multiplexed beam therefore being image transferred onto the output fibre 103.

According to embodiment alternatives of the system illustrated in respect to FIG. 1b, optical elements capable of performing a function specific to the system (notably a wavelength demultiplexing element) are introduced into the lens focal planes of the imaging systems (as replacements of or in addition to multiplexers/demultiplexers 118 and 119).

FIGS. 1c and 1d represent implementations with mirrors of systems respectively illustrated in respect to FIGS. 1a and 1b. The common elements bear the same references and are not described in any greater detail.

According to FIG. 1c, the system comprises a filter 102 or spatial light modulator, according to the invention, placed between a single mode optical fibre 101 and a mirror 120 alongside the filter 102, the fibre 101 respectively allows to propagate an incident beam 100 and an output beam 104 obtained after filtering on the filter 102 and reflection on the mirror 120.

According to FIG. 1d, the optical equaliser successively comprises the single mode input/output fibre 111, the first imaging system, the strip of filters 112 and a mirror 130 alongside the strip 112. Thus, the fibre 111 conveys the incident beam 100 and the output beam 104 obtained after filtering a spatially demultiplexed image on the strip 112 and reflection on the mirror 130.

FIG. 2a illustrates the behaviour principle of the systems presented in respect to FIGS. 1b and 1d (the means for collimating not being represented). The incident beam having n spectral components with respective wavelengths λ1 to λn is spatially demultiplexed and a spatially demultiplexed image is produced on the strip 112, as diagrammatically indicated in FIG. 2a. the strip 112 comprises n independently controlled filters 211 to 21n (preferably electrically). Thus the strip 112 allows to attenuate even block the spectral components of the incident beam.

FIG. 2b illustrates a system implementing the strip 112 of filters 211 to 21n and n input fibres 201 to 20n, respectively associated to n output fibres 221 to 22n. according to this alternative embodiment of the invention, each of the filters 211 to 21n is inserted between an input fibre 201 to 20n respectively and an output fibre 221 to 22n. Thus the system in FIG. 2b allows to independently attenuate or block n input beams 241 to 24n in order to produce n output beams 251 to 25n.

Theoretical basis allowing to optimise the filter attenuation profiles according to the invention are hereafter presented.

The mode of a single mode fibre is through the following Gaussian profile:

$${ⅇ}^{\frac{{x}^{2} + {y}^{2}}{{ω}_{0}^{2}}}$$

where:
ω₀ represents the original neck (that being the radius of the Gaussian beam taken at half-height of the energy distribution of the beam); and
x and y represent the spatial co-ordinates (in relation to the original placed in the centre of the fibre) according to two perpendicular axes in a transversal section of the fibre.

If the phase shifting Δφ is binary, the coupling coefficient η is expressed in the form: η=α+β cos Δφ where α and β are two positive coefficients dependant on the filter support. In order to minimise the coupling coefficient, Δφ must equal π.

A spatial filter (x,y) creating an optimal decoupling (corresponding to a minimal coupling coefficient η) in the single mode fibre corresponds to a filter whose support of the phase binary function (with phase shifting Δφ equal to π), D, verifies the following integral relation (minimising the difference α−β of which the coupling coefficient η depends):

$$\int {\int }_{D} \frac{{ⅇ}^{- \frac{{x}^{2}}{2}}}{\sqrt{2 π}} ⅆ x \cdot \frac{{ⅇ}^{- \frac{{y}^{2}}{2}}}{\sqrt{2 π}} ⅆ y = \frac{1}{2} \qquad relation ( 1 )$$

In the case of a constant amplitude of the signal A on the support D that can vary from 1 (in the absence of attenuation) to 0 (if there is complete attenuation), the relation (1) can be generalised as follows:

$$\int {\int }_{D} \frac{{ⅇ}^{- \frac{{x}^{2}}{2}}}{\sqrt{2 π}} ⅆ x \cdot \frac{{ⅇ}^{- \frac{{y}^{2}}{2}}}{\sqrt{2 π}} ⅆ y = \frac{1}{1 + A} \qquad relation ( 2 )$$

the concept of residual attenuation is of interest in the case of an electro-optic component, for example, where the phase shifting can be accompanied with a residual absorption or diffusion.

Among the spatial filters verifying the relations (1) and (2), particular attention is given for reasons linked to their practical advantages to the filters with an axial symmetry (case of one dimension) or punctual (case of two dimensions) and to limited support on the active part of the filter (modulating part).

In the case where a dimension can be considered as practically infinite (that being very high in reality before the other dimensions), which corresponds, in particular, to the case of making filters in the form of strips (for example the strip 112 illustrated in respect to FIGS. 1b, 1d, 2a and 2b), the criterion according to the relation (1) becomes (Dx representing the support of the active part of the filter according to the direction x supposing that the support D is infinite according to the direction y):

$${\int }_{Dx} \frac{{ⅇ}^{- \frac{{x}^{2}}{2}}}{\sqrt{2 π}} ⅆ x = \frac{1}{2} \qquad relation ( 3 )$$

FIG. 3a illustrating a filter profile such as described in the patent application WO 02/071133 has a profile with a support of the active part of the filter, infinite in the transversal plane (that meaning not limited in relation to the incident beam, according to the two dimensions of a transversal plane). It also has the inconvenience of not being optimised, notably in the presence of positioning errors of an incident beam. This point is particularly critical if used in the form of a strip or array of filters.

According to the invention, the filters 102 or the strip filters 112 of dimension 1 are of odd quantile normal distribution type defined according to one of the following relations:

$$\begin{matrix}{\int }_{- ∞}^{q} \frac{{ⅇ}^{- \frac{{x}^{2}}{2}}}{\sqrt{2 π}} ⅆ x = \frac{1}{4} \\ or & relation ( 4 ) \\ {\int }_{- ∞}^{q} \frac{{ⅇ}^{- \frac{{x}^{2}}{2}}}{\sqrt{2 π}} ⅆ x = \frac{3}{4} & relation ( 5 )\end{matrix}$$

where q represents the quantile. In the case, for example, of the first or third quantile, it represents the limit (x co-ordinate) of the active part of the filter.

The mathematical features of odd quartiles of normal distribution are presented on page 201 of the book “Calcul des probabilites” by A. Rényi, published by Dunod in 1966 (in chapter IV paragraph 13, entitled “Médiane et Quantiles”).

FIGS. 3b to 3d present different embodiments of the filter 102 or filters in a strip 112, these filters being inverted (that meaning of binary phase 0 or π) and verifying one of the relations (4) or (5).

More precisely, FIG. 3b corresponds to a quartile verifying the relation (5) of the third quartile with a central part 320 of the filter which has an axial symmetry along axis 300 and has a width L1 close to 3.0352 μm along an axis 301 perpendicular to axis 300. An incident light beam symbolised by its footprint 322 has a section of radius R substantially equal to 4.5 μm and is centred on the intersection of axes 300 and 301, the section being in a transversal plane defined by the axes 300 and 301.

On the other hand, the filter of FIG. 3a, known in itself, of order ½ (median filter) verifies the relation (3) but does not have a support limited in at least one direction and can not therefore verify the relations (4) and (5).

Supports limited to two dimensions can also be envisaged according to the invention, which is notably particularly interesting for the making of filter arrays.

Thus, filters of punctual symmetry in relation to filters of limited support verify the relations (1) and (2).

FIG. 3c corresponds to a combination of two unconnected quantile filters and more precisely to a quantile difference equal to ¼ and verifying the relation:

$${\int }_{- ∞}^{q2} \frac{{ⅇ}^{- \frac{{x}^{2}}{2}}}{\sqrt{2 π}} ⅆ x - {\int }_{- ∞}^{q1} \frac{{ⅇ}^{- \frac{{x}^{2}}{2}}}{\sqrt{2 π}} ⅆ x = \frac{1}{4} \qquad relation ( 6 )$$

with:
q1=L2/2 and q2=q1+L3.

L2 is close to 2 μm and represents the distance separating the two side parts 330 and 331 of width L3 (close to 0.867 μm) of the filter illustrated in FIG. 3c which has an axial symmetry along axis 300.

As above, an incident light beam has a section of radius R substantially equal to 4.5 μm and is centred on the intersection of the axes 300 and 301, the section being in a transversal plane defined by the axes 300 and 301.

Other combinations of quantiles can be implemented according to the invention, notably the combination of quantiles composed of a sum of quantile differences. In the case of one dimension each quantile difference corresponds to two active zones respectively associated with two symmetric bands.

For each band, each border is defined by one of these two quantiles. It is therefore necessary that the quantile differences associated with two distinct bands do not overlap.

Thus a combination of (2n+2) quantiles of normal distribution in the standard case of one dimension is written according to the relation:

$${\sum }_{i = 0}^{n} ( \begin{matrix}{\int }_{- ∞}^{q2i + 2} \frac{{ⅇ}^{- \frac{{x}^{2}}{2}}}{\sqrt{2 π}} ⅆ x - \\ {\int }_{- ∞}^{q2i + 1} \frac{{ⅇ}^{- \frac{{x}^{2}}{2}}}{\sqrt{2 π}} ⅆ x\end{matrix} ) = \frac{1}{4} with qi < qj if i < j \qquad relation ( 7 )$$

When n equal 0, there is a simple difference of quantile normal distribution. If, on the other hand, q1 equals 0, the second term of the difference equals ½ and we reduce to the case of the third quartile of one dimension. When q1 equals −∞, the second term of the difference equals 0 and the first quartile of one dimension is obtained.

It is noted that, according to the invention, q2n+1 is such that the support remains limited in at least one dimension in relation to the incident light beam.

FIG. 3d illustrates a filter based on a combination of quantiles of one dimension corresponding to three sums of quantile differences:

$${\sum }_{i = 0}^{2} ( \begin{matrix}{\int }_{- ∞}^{q2i + 2} \frac{{ⅇ}^{- \frac{{x}^{2}}{2}}}{\sqrt{2 π}} ⅆ x - \\ {\int }_{- ∞}^{q2i + 1} \frac{{ⅇ}^{- \frac{{x}^{2}}{2}}}{\sqrt{2 π}} ⅆ x\end{matrix} ) = \frac{1}{4}$$

$$with q1 < q2 < q3 < q4 < q5 < q6$$

Each term of the sum corresponds to two symmetric bands in relation to the axis 300 (direction along which the filter is not limited): three pairs of symmetric bands, respectively (340;343), 341;344) and (342;345), respectively correspond to the differences (q2−q1), (q4−q3) and (q6−q5). the different bands are limited in relation to the incident beam along the axis 301. In the case of a Gaussian beam, according to the example in FIG. 3d, the neck of the beam 322 entirely covers the bands 340 and 343 along the axis 301 and partly the bands 341 and 344. The bands 342 and 345 which are out with the footprint 322 are also useful as the energy is present out with the neck of the Gaussian beam.

FIGS. 4b to 4d have different embodiments of the filter 102 or filters in a strip 112 verifying these conditions (whereas the filter in FIG. 4a, known in itself, obtained by combining two orthogonal medians verifies the relation (2) and has a punctual symmetry but does not have a limited support).

This concept of limited support is of practical importance as a truncation of the beam in one dimension in this case can not be compensated according to the other dimension which is infinite.

In a two dimension filter configuration (on a limited support), we generally consider a Cartesian or radial representation allowing to simplify the calculations which are then similar to the case of one dimension.

More precisely, the filter 410 in FIG. 4b has two dimensions, respects the above conditions (limited support, punctual symmetry and verified relation (2)) and, in addition, has an axial symmetry along two orthogonal axes 300 and 301, thus creating a square with sides L5 close to 1.032 μm, which corresponds to the smallest filter of square adjusting pattern for an incident light beam with a section of radius R substantially equal to 4.5 μm and centred on the intersection of the axes 300 and 301. In this case, the relation (2), verified by the filter 410, becomes:

$${\int }_{- ∞}^{q3} \frac{{ⅇ}^{- \frac{{x}^{2}}{2}}}{\sqrt{2 π}} ⅆ x \cdot {\int }_{- ∞}^{q3} \frac{{ⅇ}^{- \frac{{y}^{2}}{2}}}{\sqrt{2 π}} ⅆ y = \frac{1}{2} \qquad relation ( 8 )$$

q3 is then the quantile of normal distribution of order

$$\frac{1}{2} + \frac{1}{2 \sqrt{2}}$$

or of order

$$\frac{1}{2} - \frac{1}{2 \sqrt{2}} .$$

The filter 420 in FIG. 4c has the form of a disc of radius R1 close to

$$\sqrt{\frac{log 2}{2}}$$

μm (log2 representing Napier's logarithm of 2) which corresponds to the smallest disc for an incident light beam with a section of radius R substantially equal to 4.5 μm and centred on the intersection of the axes of symmetry 300 and 301. The filter 420 satisfies the relation (2) corresponding to a quantile of normal distribution on two dimensions with active zone support limited in relation to the incident beam (reference taken at the neck of the beam).

According to the invention, a combination of quantiles corresponding to a filter of one dimension also applies in the case of two dimensions. Two specific cases of two dimensions can be easily modelled with combinations:
the case of rotational symmetry (in the case of the disc, the ring or a succession of rings) (the integral is thus calculated in polar co-ordinates) according to the relation:

$${\sum }_{i = 0}^{n} ( \begin{matrix}{\int }_{- ∞}^{q2i + 2} {\int }_{- ∞}^{q2i + 2} \frac{{ⅇ}^{- \frac{{x}^{2} + {y}^{2}}{2}}}{\sqrt{2 π}} ⅆ x ⅆ y - \\ {\int }_{- ∞}^{{q}^{′} 2 i + 1} {\int }_{- ∞}^{{q}^{′} 2 i + 1} \frac{{ⅇ}^{- \frac{{x}^{2} + {y}^{2}}{2}}}{\sqrt{2 π}} ⅆ x ⅆ y\end{matrix} ) = \frac{1}{2}$$
with qi<qj and q′i<q′j if i<j and
the case of the square or the rectangle (where the double integral can be separated into two single integrals corresponding to the case of one dimension):

$${\sum }_{i = 0}^{n} ( \begin{matrix}{\int }_{- ∞}^{q2i + 2} \frac{{ⅇ}^{- \frac{{x}^{2}}{2}}}{\sqrt{2 π}} ⅆ x {\int }_{- ∞}^{q2i + 2} \frac{{ⅇ}^{- \frac{{x}^{2}}{2}}}{\sqrt{2 π}} ⅆ y - \\ {\int }_{- ∞}^{{q}^{′} 2 i + 1} \frac{{ⅇ}^{- \frac{{x}^{2}}{2}}}{\sqrt{2 π}} ⅆ x {\int }_{- ∞}^{{q}^{′} 2 i + 1} \frac{{ⅇ}^{- \frac{{y}^{2}}{2}}}{\sqrt{2 π}} ⅆ y\end{matrix} ) = \frac{1}{2}$$
with qi<qj and q′i<q′j if i<j.

FIG. 4d presents a ring-shaped adjustable pattern filter 430 of external radius R3 close to 2.48 μm and of internal radius R2 of about 1.1 μm capable of filtering an incident light beam with a section of radius R substantially equal to 4.5 μm and centred on the intersection of the axes of symmetry 300 and 301. The filter 430 satisfies the relation (2) and more precisely corresponds to a difference of radial quantiles with limited support, respectively (of radius R3) and D2 (of radius R2):

$$\int {\int }_{D1} \frac{{ⅇ}^{- \frac{{x}^{2} + {y}^{2}}{2}}}{\sqrt{2 π}} ⅆ x ⅆ y - \int {\int }_{D2} \frac{{ⅇ}^{- \frac{{x}^{2} + {y}^{2}}{2}}}{\sqrt{2 π}} ⅆ x ⅆ y = \frac{1}{2} \qquad relation ( 9 )$$

The filters illustrated in respect to FIGS. 3b, 3c and 4b to 4d are defined for a binary phase trip Δφ lying between 0 and π. According to an alternative of the invention, so as to satisfy some of the technological constraints, the stiffness of the phase trip is reduced and/or the more complex phase profiles are implemented. It has the advantage of releasing the technological constraint of the stiffness of the filter or of the phase trip.

In the case of one dimension, the quartile principle according to the relations '4) and (5) remain valid and only the phase value is modified.

More generally, in the case of a filter of one or two dimensions of any variable phase profile, to determine the geometry of the optimal support, first of all the coupling coefficient is calculated according to the phase profile, a maximum phase and a tested support. In order to obtain maximum attenuation, a nullifying of the coupling coefficient is search for and then the maximum phase can be chosen and the corresponding optimal support.

In order to optimise the filter, the following method, according to the invention, is applied:
first of all, determining a coupling coefficient η of the filter according to a phase profile, to a maximum phase and to a filter support; then
minimising the coupling coefficient; and
determining the support substantially corresponding to a minimum coupling coefficient.

FIGS. 8a to 8d illustrate this principle in two simple cases (parabolic or triangular phase profile) which in addition is of technological interest as it constitutes an approximate limit in real case.

A parabolic phase profile (notably of micro-lens type) corresponds, for example, to a transversal field effect in the case of an electro-optical spatial modulator or even a parabolic distortion of the membrane of a DMD such as described in the article “Monolithic Piezoelectric Mirror for Wavefront Correction”, by J. Feinleib, S. Lipson and P. Cone published in Applied Physics Letters, Vol. 25, pages 311 to 313 in 1974.

In this case, the optimal phase is no longer π and an analytic expression can be obtained of the necessary quartile and phase shifting value Δφ by calculating the coupling coefficient η which can be written as:
η=Δ_{φ}(1+B sin(Δφ)) relation (10)

The coefficient value B, (B>0) depends on the dimensions of the modulator and can be brought to 1, by resolving the following equation:

$${ⅇ}^{- 2 X} = \frac{4}{3 π} X \qquad relation ( 11 )$$

where X is the square of the ratio of the filter support on the width of the neck of the Gaussian beam and the smallest phase shift nullifying η is 3π/2 (corresponding to sin(Δφ)=−1).

Then, relation (10) can be written as:
η=Δ_{φ}(1+sin(Δφ)).

From this relation the filter is optimised by defining the support substantially corresponding to a minimal coupling coefficient.

FIG. 8a illustrates the adaptation principle of the quartile value in the case of a binary profile 82 or phase parabolic profile 83.

FIG. 8b illustrates a combination of bits of binary and parabolic profiles, where 1 is the parabolic half support and L the binary half support. The optimal phase then varies according to the ratio L/1 between π(l=0) and 3π/2 (L=0 ).

The smallest support is obtained when 1 equals 0 (binary case corresponding to the profile 82).

A triangular phase profile (notably of micro-prism type) corresponds, for example, to an etching error (shadow effect) or to a distortion in a mirror by a micro-actuator such as described in the aforementioned article by Feinleib.

A transversal field effect can also be roughly modelled by this case. The first variable is the slope of the prism.

FIG. 8c illustrates the variation of the quartile according to a phase modulation of isosceles triangle type (double prism). In this case, there is a quartile optimising the decoupling and showing that the smallest phase shift nullifying q is close to 8π/5. It is noted that the support is smaller than the equivalent binary filter.

A combination by bits of triangular and binary profiles according to FIG. 8d is also considered; this case corresponds to the trapezoidal profiles which constitute a good modelling of etching effects and membrane distortion of a micro-mirror. The optimal phase then varies according to the ratio L′/l′ between π(l′=0) and 8π/5(L′=0) (where l′ is the triangular half support and L′ the binary half support). The smallest support is obtained when L′ equals 0 (corresponding to a double prism).

As mentioned above, the odd quartiles of normal distribution have the advantage for filters 102 or strip filters 112 such as presented in respect to FIGS. 2a and 2b, of a better tolerance to the positioning errors. This comes from the fact that the dynamic is optimal when the area of the spot covering the pixel equals half the total area, the positioning of the spot on the pixel is therefore a very important step as the distribution of energy follows a Gaussian rule.

This point becomes all the more critical when it comes to aligning several spots on a filter strip as required in the case of a DCE. FIG. 5 illustrates the impact of this interference (positioning error in relation to the centre of the filter, given according to the intercept point 501 and expressed in microns), in particular on the attenuation dynamic given according to the y axis 500 and expressed in dB:
on a median filter known in itself is based on the profile illustrated in respect to FIG. 3a, according to the curve 512;
on a quartile of order 3 (odd quartile) corresponding to the profile illustrated in respect to FIG. 3b, according to the curve 510; and
on a combination of quartiles corresponding to the profile illustrated in FIG. 3c, according to the curve 511.

The filter corresponding to the third quartile is the least sensitive to positioning in relation to the spot. Thus, for a positioning error of the spot equal to 0.2 μm, the attenuation difference between the curves 512 (in the case of a median) and 510 (odd quartile) is about 25 dB. This odd quartile filter also has many other advantages regarding its technological implantation.

The positioning parameter is more critical, for example, than a focalising error in the case of using single mode fibre such as detailed in the article “Propagation and Diffraction of Truncated Gaussian Beam” by V. Nourrit, J L de Bougrenet de la Tocnaye and P. Chanclou, published in JOSA-A, Vol. 18, pp 546-554, in 2001.

The odd quartile filter is therefore particularly well suited to the making of a DCE.

Among the odd quartile filters, a filter has a specific advantage, it is the third quartile such as illustrated in FIG. 3b. In the case of a configuration implicating the juxtaposition of pixels operating on each wavelength where the wavelengths are spatially demultiplexed according to FIG. 2a or separated according to FIG. 2b, and when these spectral channels or bands are well established (in the case of a blocker or DCE), it is necessary to optimise the interval between each of these filters in respect to the bandwidth per channel.

FIGS. 6c and 6d represent a strip 112 of filters 623 to 625 respectively of third quartile or quartile combination type, in a configuration optimising the size (respectively d1 and d2) of the interval between two active zones (i.e. the phase or delay variation zone).

To obtain the same result (active zone dimension/total pixel dimension) with the median filter in FIG. 3a, the bandwidth must be reduced by ⅔ as illustrated in respect to FIGS. 6a and 6b according to two configurations.

The filter 102 is therefore technologically the easiest to make and is particularly well suited to implantation in the from of strips 112 (it optimises the bandwidth). It is moreover the binary filter which authorises the biggest inter-pixel zone. The benefits of the latter feature will now be considered.

The use of a material, for example electro-optic, for the phase modulation or electro-mechanic for variable delay of optical path length, could introduce additional constraints on the ration between the active zone and the total dimension of the pixel, linked to the technological choice of the means for phase shifting. In the case of a realisation in the form of strips or arrays, it is very useful to optimise this filling factor. Hereafter, two types of phase shifting will be envisaged:
electro-mechanic means (for example MEMS type malleable micro-mirrors, DMD type malleable membranes); and
electro-optic modulators (notably of liquid crystal type, nano-PDLC type . . . ).

a) In the case of electro-mechanic means (micro-mirrors (MEMS) or malleable membranes (DMD)).

Each malleable mirror or membrane is separated by one or several activation (actuator) or cantilever devices. These zones are indispensable and are genuine dead zones for the modulator in particular in bitmap form. The use of the third quartile according to a profile, for example of two dimensions such as described in respect to FIGS. 4b and 4c, allow to optimise the dead zone, as this quartile is the binary quartile which optimises the filling factor.

FIGS. 7a and 7b respectively illustrate a plan view and a sectional view of a strip 700 of filters 701 to 704 in compliance with the invention according to a profile of two dimensions such as illustrated in respect to FIG. 4c. According to different alternative embodiments of the invention, the filters 701 to 704 are of whatsoever type in compliance with the invention such as illustrated notably in respect to FIGS. 3b, 3c and 4b to 4d. The well suited filters 701 to 704 can notably be of whatsoever geometry (for example radial symmetry for a DMD) or implanted in the form of one or two dimension(s) implementing, for example, means for phase shifting of MEMS or DMD type. The filters 701 to 704 are associated to electrodes piloting them through the applying of a corresponding voltage 710 to 713.

b) In the case of an electro-optic modulator.

In the case of an electro-optic modulator (for example of electrically controlled liquid crystal or nano-PDLC type), two configurations illustrated in respect to FIGS. 7c to 7f are possible.

According to the first configuration, the modulator illustrated in respect to FIGS. 7c (plan view) and 7d (sectional view) comprises juxtaposed and evenly diffused pixels 721 to 724 and 730 to 735. The use of the third quartile in this configuration resorts to activating one pixel out of three (pixels 721 to 724 activated by applying a voltage V via the respective means for controlling 741 to 744 and pixels 730 to 735 deactivated by applying a nil voltage via the respective means for controlling 750 to 755). The electric interaction can thus be limited between neighbouring pixels (transversal field effect sensitive to a greater or lesser extent according to the technology employed).

A second configuration illustrated in respect to FIGS. 7e (plan view) and 7f (sectional view) consists in depositing solely the adjustable zone comprising filters 761 to 764 in the central zone. The use of the third quartile for filters 761 to 764, which optimises the active zone to dead zone ratio renders this technological operation easier. Taking into account the dimension of the interval, this zone can thus be used to electrically passivate the active zones via the use of the voltages sources 770 to 773. According to an alternative, the passivation is optical.

This has the added benefit of allowing sharper phase transitions between two phase levels compared to the previous configuration and of further limiting the electric interaction between pixels, and consequently the transversal field effects.

In these two cases, the third quartile is the binary filter the easiest to implant and which has the biggest inter-pixel interval, thus facilitating both the inter-pixel passivation operations and the limiting of the transversal field effects.

The principle of the binary filter of odd quartile normal distribution can be applied in the event of a slightly multimode guided structure of rectangular mode. The filter is made differently and by means of an electro-optic element. In this case, the field application is not done parallel to the optical axis, but perpendicular to it.

FIG. 9 illustrates an AWG (Arrayed Wave Guide) which comprises:
an input wave guide 900 associated to a non-represented input fibre;
phasers (delay lines in the form of wave guides) 910 to 915 and 930 to 935;
a star coupler 901 interfacing the input fibre 900 with the phasers 910 to 915;
phase shifting filters 920 to 925 respectively linking phasers 910 to 915 to phasers 930 to 935;
output wave guides 903 to 906 each associated to a different wavelength λi (i lying between 1 and n) and each intended to transmit an output beam towards an output fibre; and
a lens 902 linking phasers 930 to 935 to guides 903 to 906.

The filters 920 and 925 are similar. By way of illustration, the filter 921 comprises an active zone 940 linking the phasers 921 and 931. In this embodiment, the adjustable zone is directly etched in the guide and the phase shifting is obtained by applying an electric field perpendicular to the guide. The value of this phase shifting is determined, notably, by the length of the active zone L. the guided structure is therefore well suited to implanting the third quartile as it guarantees binary phase shifting.

The AWG configuration is equivalent to a free space assembly, namely 4f, such as illustrated in respect to FIG. 1b, with the Fourier plane at the centre of the assembly.

The main benefit of this solution is to be able to make an equaliser or spectral band selector by this means using a demultiplexing configuration of AWG type as indicated in the article “Dynamic Digital Holographic Wavelength Filtering” by M. C. Parker, A. D. Cohen and R. J. Mears, published in JLT, Vol. 16, NO 7, pp 1259-1270, in 1998.

Of course, the invention is not restricted to the aforementioned embodiments.

In particular, those skilled in the art can develop alternatives in the defining of filters verifying the aforementioned conditions, and notably of odd quartiles and of limited support quantile combinations.

It is noted that the implementing of filters is not restricted to an attenuation function but extends to all systems with a single mode output fibre, in particular equalisers, attenuators, selector switches, mode converters . . . .

The implementing of the invention is not restricted to fibres whose adjustable patterns are in the same plane, but also extends to fibres whose limited support patterns on at least one dimension (in relation to the incident beam) are in distinct planes: thus, for example, the two parts 330 and 331 of the filter illustrated in respect to FIG. 3 are not necessarily in the same plane but can be respectively placed in planes offset in relation to the propagation direction of the incident beam. More generally, a programmable filter pattern can be placed in several planes perpendicular to the axis of propagation of the incident beam, the sum of the adjustable pattern footprints (or global footprint) respecting the conditions of limited support in relation to the incident beam on at least one dimension and corresponding to a combination of quantiles.

1. Spatial phase filter (102, 112, 920) capable of receiving an incident light beam so as to transmit it to a single mode output fibre (104, 111, 221), said filter being adapted to be positioned substantially perpendicular to the direction of propagation of said beam and comprising a spatially variable phase profile and being adapted to excite the evanescent modes of said output fibre, wherein said profile has:
an adjustable pattern with a phase distribution substantially corresponding to a combination of at least one quantile of normal distribution on at least one dimension (300, 301); and
a phase shifting zone support (320, 330, 331, 340 to 345) limited in relation to said incident beam according to said at least one dimension.

2. Spatial filter set forth in claim 1, wherein said profile has an adjustable pattern with a phase distribution substantially corresponding to an odd quartile of normal distribution on a dimension perpendicular to the direction of propagation of said incident beam.

3. Filter set forth in claim 2, wherein its phase distribution substantially corresponds to a third quartile of normal distribution on said dimension.

4. Spatial filter set forth in claim 3, wherein said the combination is a sum of at least one difference of two quantiles of normal distribution on one dimension perpendicular to the direction of propagation of said incident beam, said sum being equal to ¼ or ¾.

5. Spatial filter set forth in claim 4, wherein it has an axial symmetry.

6. Filter set forth in claim 1, wherein said profile has:
an adjustable pattern with a phase distribution substantially corresponding to a combination of at least one quantile of normal distribution on the two dimensions of a transversal plane in relation to said incident beam; and
an active zone support limited in relation to said incident beam according to said dimensions.

7. Filter set forth in claim 6, wherein said combination belongs to the group comprising:
a quantile of normal distribution; and
a difference of two distinct quantiles of normal distribution.

8. Spatial filter set forth in claim 7, wherein it has a punctual symmetry.

9. Spatial filter set forth in claim 8, wherein a first part of said profile (82, 86, 87) is square or rectangular on said dimension(s).

10. Filter set forth in claim 9, wherein the phase shifting on said first part of said profile is equal to π.

11. Spatial filter set forth in claim 10, wherein a second part of said profile (83, 84) is parabolic on said dimension(s).

12. Spatial filter set forth in claim 11, wherein a third part of said profile (85, 87) is triangular on said dimension(s).

13. Spatial filter set forth in claim 12, wherein it comprises means for controlling said variable attenuation on one part of said profile.

14. Filter set forth in claim 13, wherein said means comprise at least an electro-optic or electro-mechanic adjusting element, that can be controlled.

15. System (112) capable of receiving at least one light beam and comprising at least one filter (211 to 21n) set forth in claim 14.

16. System set forth in claim 15, wherein it comprises at least two said filters.

17. System set forth in claim 16, wherein each of said filters comprises an electrically controlled adjusting zone.

18. System set forth in claim 17, wherein it comprises means for imaging, at least one of said filters being positioned in an imaging plane of said means for imaging.

19. System set forth in claim 18, wherein it comprises means for wavelength demultiplexing of said light beam(s) so as to create demultiplexed light beams intended to be filtered by said filters.

20. System set forth in claim 19, wherein it comprises means for selective blocking of at least some wavelengths of said light beam(s).

21. System set forth in claim 20, wherein it comprises means for routing said light beam.

22. Method for filter calculating set forth in claim 14, wherein it comprises:
a step for determining a coupling coefficient of said filter according to a phase profile, a phase maximum and a support of said filter;
a step for minimising said coupling coefficient; and
a step for determining said support substantially corresponding to a minimal coupling coefficient.
